(19) United States
(12) Patent Application Publication
(10) Pub. No.: US 2014/0337359 A1
(43) Pub. Date: Nov. 13, 2014

(54) SYSTEMS AND METHODS FOR ESTIMATION AND APPLICATION OF CAUSAL PEER INFLUENCE EFFECTS

(71) Applicant: OFFERGRAPH LLC, Austin, TX (US)

(72) Inventor: Edoardo M. Airoldi, Cambridge, MA (US)

(21) Appl. No.: 14/323,305

(22) Filed: Jul. 3, 2014

Related U.S. Application Data
(60) Provisional application No. 61/820,495, filed on May 7, 2013.

(51) Int. Cl. G06F 17/30

(52) U.S. Cl. CPC G06F 17/3053
USPC 707/748

(57) ABSTRACT

The present disclosure describes systems and methods for quantifying causal peer influence within a social network for improved business intelligence. Influencers of a group, or individuals with a greater amount of influence on the group, may be identified and their amount of influence on the group or a subset of the group estimated. The analysis may provide actionable insights into the group, allowing improved marketing or advertising results, prioritization of offers, improved design and execution of A/B tests, or other such features.

### RELATED APPLICATIONS

The present application claims priority to and is a nonprovisional application of U.S. Provisional Application No. 61/820,495, entitled “Systems and Methods for Estimation and Application of Causal Peer Influence Effects, filed May 7, 2013, the entirety of which is hereby incorporated by reference.

### FIELD

The present application relates to systems and methods for quantifying causal peer influence within a social network for improved business intelligence.

### BACKGROUND

Typical statistical analysis of variable effects tends to ignore social influences, due to the complexity of estimation of the effects of such influences and lack of intuitive sense about how such influences work. For example, standards for A/B testing in the health care industry typically assume that no social interference is involved: i.e. that one patient's treatment does not affect any other patient's outcome. The same standards are applied in product marketing and advertising, with various offers presented to individuals and the results of said individuals' decision to purchase or not purchased aggregated to identify a statistical correlation. However, such a correlation is at best a rough estimation, as it ignores inter-party influence effects such as friends being more likely to purchase the same products, and at worst may be entirely inaccurate if the amount of influence is greater than the error range for the statistical correlation.

### SUMMARY

The present disclosure describes systems and methods for quantifying causal peer influence within a social network for improved business intelligence. Influencers of a group, or individuals with a greater amount of influence on the group, may be identified and their amount of influence on the group or a subset of the group estimated. The analysis may provide actionable insights into the group, allowing improved marketing or advertising results, prioritization of offers, improved design and execution of A/B tests, or other such features.

For example, in some embodiments of these systems and methods, a social network or a portion of a social network accessible to the system (e.g. a subset of users of the social network who have “liked” or purchased an item, agreed to participate in a survey or promotion, or are associated with the administrator of the system such that their profiles are accessible by the system) may be analyzed to identify causal influences within the group. Causal estimands or parameters under analysis may be defined in terms of extended potential outcomes, such as that a potential outcome for an individual is not only a function of the treatment or perturbation applied to the individual, but also a function of the treatment or perturbation applied to the individuals neighbors or linked users at specified distances within the social network. This allows for enhanced business intelligence and analytics, as in some embodiments, the analysis results may identify how to get customers to purchase target items or amounts by identifying their most influential friends or social graph neighbors. In educational contexts, the potential outcome may include higher test scores or better grades, and the social analysis may identify the most influential students to match with peers or target for extra instruction that can be passed on to other individuals. In military intelligence contexts, the analysis may suggest ways to induce offline social unrest via online means or individuals. In health care contexts, the analysis may identify the most important targets for vaccinations within a network, targeted medication trials, or other procedures that can then have further effects on the individual's neighbors. In some embodiments, various randomization strategies discussed herein may be employed to identify control groups or groups for analysis, including cluster randomizations and insulated neighbor randomizations. While simply selecting individuals and perturbations at random may be sufficient when networks and neighbor influences are ignored, these randomizations may result in false or biased estimates depending on network topology and which individuals are selected. For example, if a random selection results in all individuals selected for a treatment being neighbors in a network, and all individuals selected for no treatment or used as a control group are neighbors in the network, with no or few individuals linked to both treated and untreated individuals, third party influence effects may not be able to be estimated. Accordingly, the methods and strategies discussed herein may provide network-aware randomization and account for cluster topology to avoid unwanted estimation bias.

The systems and methods discussed herein allow causal effects of various aspects of individuals or behaviors to be identified, using variables such as features of the influencer, features of the influenced, features of the message (e.g. content, media type, etc.), and with potential outcomes of interest such as a target behavior to be induced (e.g. online behaviors such as purchases, tweets or retweets, “likes”, reviews, etc. or offline behaviors such as votes, store visits, purchases, attendance at an event, etc.). In some embodiments, these methods may include frequentist inferences via randomization-based statistical analysis, or Bayesian model-based estimations of effects.

In one aspect, the present disclosure is directed to a system for applying quantified causal peer influence within a social network. The system includes a first device in communication with a second device of a social network service, the first device comprising a processor configured for executing an analyzer and a recommendation engine. The analyzer is configured to receive an identification of a first target within the social network, and retrieve an identification of a plurality of targets neighboring the first target. The analyzer is also configured to calculate, for each of the plurality of targets neighboring the first target, an influence score, and identify, based on the calculated influence scores for each of the plurality of targets neighboring the first target, a first influencer of the first target. The recommendation engine is configured to identify a first status of the first influencer; select, from a database, a first recommendation associated with the identified first status; and transmit the selected first recommendation to a second device of the first target.

In some implementations, the analyzer is further configured to receive the identification of the plurality of targets neighboring the first target from a device of the social network service. In other implementations, the analyzer is further configured to identify a percentage of the plurality of targets that are interconnected; and determine whether the identified percentage is above a predetermined threshold. In a further implementation, the analyzer is further configured to calculate the influence scores via insulated neighbors randomization (INR), responsive to the identified percentage being below the predetermined threshold. In another further implementation, the analyzer is further configured to calculate the influence scores via simple sequential randomization (SSR), responsive to the identified percentage being above the predetermined threshold.

In some implementations, the analyzer is further configured to identify, as the first influencer, a target neighboring the first target having a highest calculated influence score of the plurality of targets. In a further implementation, the analyzer is further configured to identify, as the first influencer, a target neighboring the first target having a calculated influence score above a predetermined threshold.

In one implementation, the recommendation engine is further configured to identify the first status as the most recent status of a plurality of statuses of the first influencer. In another implementation, the first recommendation associated with the identified first status comprises a recommendation of the first status to the first target. In still another implementation, the analyzer is further configured to identify a second influencer of the first target, based on the calculated influence scores for each of the plurality of targets; the recommendation engine is further configured to identify a second status of the second influencer, and select the first recommendation associated with the identified first status and second status.

In another aspect, the present disclosure is directed to a method for applying quantified causal peer influence within a social network. The method includes receiving, by an analyzer executed by a first device in communication with a second device of a social network service, an identification of a first target within the social network. The method also includes retrieving, by the analyzer, an identification of a plurality of targets neighboring the first target. The method also includes calculating, by the analyzer for each of the plurality of targets neighboring the first target, an influence score. The method further includes identifying, by the analyzer, a first influencer of the first target based on the calculated influence scores for each of the plurality of targets neighboring the first target. The method also includes identifying, by a recommendation engine executed by the first device, a first status of the first influencer. The method also includes selecting, by the recommendation engine from a database, a first recommendation associated with the identified first status. The method further includes transmitting, by the recommendation engine, the selected first recommendation to a second device of the first target.

In some implementations, the method includes receiving the identification of the first target from a device of the social network service. In other implementations, the method includes identifying, by the analyzer, a percentage of the plurality of targets that are interconnected; and determining, by the analyzer, whether the identified percentage is above a predetermined threshold. In a further implementation, the method includes calculating, by the analyzer, the influence scores via insulated neighbors randomization (INR), responsive to the identified percentage being below the predetermined threshold. In another further implementation, the method includes calculating, by the analyzer, the influence scores via simple sequential randomization (SSR), responsive to the identified percentage being above the predetermined threshold.

In some implementations, the method includes identifying, as the first influencer, a target neighboring the first target having a highest calculated influence score of the plurality of targets. In a further implementation, the method includes identifying, as the first influencer, a target neighboring the first target having a calculated influence score above a predetermined threshold.

In some implementations, the method includes identifying, by the recommendation engine, the first status as the most recent status of a plurality of statuses of the first influencer. In other implementations, the first recommendation associated with the identified first status comprises a recommendation of the first status to the first target. In still other implementations, the method includes identifying, by the analyzer, a second influencer of the first target, based on the calculated influence scores for each of the plurality of targets; identifying, by the recommendation engine, a second status of the second influencer; and selecting, by the recommendation engine, the first recommendation associated with the identified first status and second status.

### BRIEF DESCRIPTION OF THE FIGURES

FIG. 1A is a diagram of an embodiment of a social graph with a “candy network” illustrating the effects of selection bias;

FIG. 1B is a diagram of an embodiment of a social graph with an insulated neighbors randomization (INR) algorithm used to identify a control group;

FIG. 2 is a plate diagram of an embodiment of a Poisson random network linear treatment model for modeling network uncertainty;

FIG. 3 is a state diagram of an embodiment of a Markov chain Monte Carlo algorithm for determining influence exposure;

FIG. 4 is a diagram of an embodiment of a system for analysis of causal effects within a social network;

FIG. 5 is a flow chart of an embodiment of a method for presenting an offer to a user based on an estimation of causal influence effects; and

FIG. 6 is a block diagram of an exemplary computing device useful for practicing the methods and systems described herein.

In the drawings, like reference numbers generally indicate identical, functionally similar, and/or structurally similar elements.

### DETAILED DESCRIPTION

The following description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

For purposes of reading the description of the various embodiments below, the following descriptions of the sections of the specification and their respective contents may be helpful:
Section A describes algorithms for estimation of causal peer influence effects;
Section B describes embodiments of systems and methods for applying causal influence estimations to improve business intelligence; and
Section C describes embodiments of computing devices which may be useful for practicing embodiments described herein.

### A. Estimation of Causal Peer Influence Effects

The broad adoption of social media has raised the question of how to quantify peer influence. However, the estimation of causal peer influence effects presents technical challenges, including how to account for social interference in existing causal frameworks, and how to deal with complex response functions and network uncertainty. Extending the potential outcomes framework to deal with interference, in some embodiments, novel causal estimands of peer-influence are generated via a randomization procedure that helps identify causal-peer influence effects. In one embodiment, a first frequentist procedure requires knowledge of the network but operates under complicated response functions. In another embodiment, a second Bayesian procedure helps reduce bias and accounts for network uncertainty, but relies on a linear response assumption. Either embodiment may provide a bias-information trade-off, with randomizations that identify more causal information leading to more biased estimates.

In causal inference, interference among units of analysis may exist when a treatment or intervention on a unit has an effect on the response of another. These effects are known as spillover effects in economic theory, but when the units are humans and the effects originate from a unit's peers, e.g., friends or classmates, they are known as peer influence effects. The widespread adoption of social media gives rise to many instances in which it may be beneficial to quantify peer influence, such as in advertising to a demographic group or cohort.

The Neyman-Rubin model, sometimes referred to as the Rubin Causal Model (RCM) is the most widely-used causal framework in statistics and the social sciences and is an approach to the statistical analysis of cause and effect based on the framework of potential outcomes, in which each unit has different potential outcomes depending on their assignment to a condition or variable. For example, assume 2 units who are about to receive a treatment, say, an aspirin. Denote with Zᵢ ∈ {0,1} whether unit i received the treatment (Zᵢ=1) or not (Zᵢ=0) and Z=(Z₁, Z₂) the entire assignment vector. Also denote the response to the treatment, say, severity of headache, with Yᵢ(Zᵢ):

TABLE 1
Causal inference as a missing data problem under the Neyman-Rubin
model Under the Stable Unit Treatment Value Assumption (STUVA),
it is assumed that there is no interference: that is, the outcome of
individual i is only a function of its treatment Zᵢ.

| | |
|---|---|
| “Ideal” world | Real world |

| Unit | Zᵢ = 0 | Zᵢ = 1 | Zᵢ = 0 | Zᵢ = 1 |
|---|---|---|---|---|
| 1 | Y₁(0) | Y₁(1) | Y₁(0) | ? |
| 2 | Y₂(0) | Y₂(1) | ? | Y₂(1) |

In an ideal world we would observe all the possible outcomes (left part of table). We define the causal estimand in this ideal scenario, where we have access to outcomes for all possible treatments. For example, a natural definition of the causal effect of taking aspirin would be: μ=(1/2)·[Y₁(1)+Y₂(1)−Y₁(0)−Y₁(0)]

In the real world, however, only one outcome can be observed for each unit, since one cannot both take and not-take the aspirin, while the other will be missing (denoted with “?” in table 1). A desirable feature of the potential outcome framework is the ability to define causal estimands in terms of individual-level potential outcomes—even though only average causal estimands are estimable in practice.

In some embodiments of the systems discussed herein, estimation can be performed in two distinct ways. In randomization based inference, treatment is randomized and estimators are obtained through the observed outcomes. Here, if aspirin assignment was randomized, then a natural estimator is \hat{n}=Y₂(1)−Y₁(0), and such an estimator would be unbiased. In a model based approach, the outcomes can be modeled conditioned on the assignment and the observed covariates, e.g. assume Yᵢ(Zᵢ) is normal with mean a+Zᵢ·τ.

The systems discussed here utilize a new causal estimand for peer influence effects, δₖ, by extending the potential outcomes framework to account for interference in a social network. Different ways may be utilized in various embodiments to estimate this causal estimand, sequential randomization, and a model-based approach, each discussed in more detail below.

In one embodiment, a network may be denoted as G=(V, E), where V is the vertex set and E is the edge set. For a node i ∈ V, ᵢ is defined as the neighborhood of the node, excluding i. There are N total nodes and every node i has nᵢ neighboring nodes. The N×1 treatment assignment vector is denoted by Z and for a subset w ⊂ V, let Z_{w} be the assignment vector of only the nodes in w. Thus, Zᵢ is the assignment vector of the neighbors of i. Also, let Vₖ be the set of nodes that have at least k neighbors and ᵢₖ be the set of neighbors of i ∈ Vₖ who are also neighbors to at least one other node in Vₖ. Define ᵢₖ=∪ᵢ ᵢₖ as the set of shared neighbors. Denote also mᵢₖ|ᵢₖ|, i.e. the number of neighbors of i who are shared with other nodes in Vₖ as well.

A node or an experimental unit i is “treated” if Zᵢ=1 and it is “in control” or untreated if Zᵢ=0. Given D={0, 1}, then Zᵢ ∈ D. In the first case, unit i receives primary effects and in the latter it receives k-level peer influence effects. Furthermore, we say that a unit i is “exposed” if Zᵢ=0 and at least one neighbor is treated (e.g. the exposed unit is itself untreated, but is directly connected to a treated unit). A unit i ∈ Vₖ is k-exposed if it is exposed and exactly k neighbors are being treated and the corresponding treatment assignment is called a k level assignment. We say that a unit is non-exposed when Zᵢ=0 and Z_{Ni}=0, i.e. the unit and all neighbors are in control for i.

The response of unit i (potential outcome) under treatment Z is denoted by Yᵢ(Z)≡Yᵢ(Zᵢ, Z−1), where Z−i is the vector of assignment Z excluding i's assignment. Define Z(Nᵢ; k) to be the set of all assignments on Nᵢ in which exactly k neighbors of i get treated (a total of

$$( \begin{matrix}{n}_{i} \\ k\end{matrix} )$$

such assignments). Define Z₁(Nᵢ; k) as the set of all assignments in Z(Ni; k) for which ∃ⱼ, Zⱼ=1 and j ∈ᵢₖ, i.e. at least one of the shared neighbors of i gets treated. Denote as Z₀(Nᵢ; k) the set of assignments Z(Nᵢ; k)\Z₁(Nᵢ; k), i.e. node i is k-level exposed and all shared neighbors are put in control. Therefore, Z₀(Nᵢ; k)∪ Z₁(Nᵢ; k)=Z(Nᵢ; k) and Z₀(Ni; k)∩ Z₁(Nᵢ; k)=, i.e. the two sets are disjoint and form collectively the entire set of k-level assignments.

$$Last , define {ρ}_{i} = {( \begin{matrix}{n}_{i} \\ k\end{matrix} )}^{- 1} , \\ {ρ}_{0 , i} = {( \begin{matrix}{n}_{i} - {m}_{ik} \\ k\end{matrix} )}^{- 1}$$

$$and$$

$${ρ}_{0 , i} = {( 1 \text{/} {ρ}_{1} - 1 \text{/} {ρ}_{0 , i} )}^{- 1} .$$

Accordingly, ρᵢ is the probability of one random k-level assignment for unit i and ρ_{0,i} is the probability of a random assignment given that i's shared neighbors are put in control. Note that |Z₀(Nᵢ; k)|=1/ρ_{0,i} and |Z₁/(Nᵢ; k)|=1/ρ_{1,i}, so that 1/ρᵢ=1/ρ_{0,i}+1/ρ_{1,i}.

In the classical potential outcomes framework, SUTVA (i.e. Stable Unit Treatment Value Assumption) is assumed: Yᵢ(Z)=Yᵢ(Zᵢ), meaning that the outcome of unit i depends only on the treatment it receives and not on the treatments on others. This is violated in the presence of interference. Accordingly, in some embodiments of the systems discussed herein, the following assumption is used in place of SUTVA:

Assumption 1. [Constant responses over reference groups] ∀ᵢ, Yᵢ(Z)=Yᵢ(Zᵢ, Z_{Ni}), i.e. a unit is affected only by the treatment of itself or the neighborhood.

Formally, the response function of a node can be denoted by i is Y(Zᵢ,z) and is a map D×D^{|Ni|}→R. For brevity, we denote the response Yᵢ(0, z=0) by Yᵢ(0).

Definition 1. [Main estimand for peer influence effects] Define as δₖ the causal estimand of k-level effects as follows:

$${δ}_{k} ≡ \frac{1}{\vert {V}_{k} \vert} {\sum }_{i ∈ {V}_{k}} [ {( \begin{matrix}{n}_{i} \\ k\end{matrix} )}^{- 1} {\sum }_{z ∈ Z ( {𝒩}_{i} ; k )} {Y}_{i} ( 0 , z ) - {Y}_{i} ( 0 ) ] \qquad ( 1 )$$

Definition 2. [Estimand for primary effects] Define as ξ the causal estimand of primary effects as follows.

$$ξ ≡ \frac{1}{N} {\sum }_{i} {Y}_{i} ( 1 , z = 0 ) - {Y}_{i} ( 0 ) \qquad ( 2 )$$

Definition 3. [Additional peer influence effects estimands]

(“insulated neighbors”):

$${δ}_{k , 0} = \frac{1}{N} {\sum }_{i} {ρ}_{0 , i} \cdot {\sum }_{z ∈ {Z}_{0} ( {𝒩}_{i} ; k )} {Y}_{i} ( 0 , z ) - {Y}_{i} ( 0 ) \qquad ( 3 )$$

(“non-insulated neighbors”):

$${δ}_{k , 1} = \frac{1}{N} {\sum }_{i} {ρ}_{1 , i} \cdot {\sum }_{z ∈ {Z}_{1} ( {𝒩}_{i} ; k )} {Y}_{i} ( 0 , z ) - {Y}_{i} ( 0 ) \qquad ( 4 )$$

Definition 4. [Valid causal estimates] A causal estimate from a randomization is valid if at least one node was assigned to the prescribed treatment and at least one node was assigned to control. Otherwise, the estimate is not valid or non-causal.

In one embodiment, the estimand δₖ captures the peer effects by averaging over all potential outcomes of the k-level assignments of every node. The estimand δ_{k,0} captures the peer effects given that all shared neighbors have been put in control. Similarly the estimand δ_{k,l} measures the peer effects when at least one shared neighbor receives treatment. The difference between the two is exactly proportional to the bias of our proposed randomization. In other embodiments, the estimand may be calculated based off medians rather than averages, and ratios rather than differences, or having a proportion of neighbors treated rather than an exact number k, discussed in more detail below.

Causal Inference through Randomization

In one embodiment, the system may utilize a straightforward randomization algorithm which iteratively picks units and treatments at random. This is effectively a sequential randomized design. Assuming the existence of a function sum( ) which computes the sum of a vector, and sample( ) which samples at random from a vector(if sample accepts an argument n, then it will sample exactly n elements), the pseudocode is:

Algorithm 1 Simple Sequential Randomization: SSR(G, Z).
Inputs: G network, Z treatment vector

```
while i←sample{i:i εVₖ & S(Z_{Ni})≦k} do =
      w ← sample{z : z εD^{|Ni|} & (s(z)−k)·s(z) = 0}
      Z_{Ni} ← w
      Zᵢ ← 0
end while
```

Simple sequential randomization (SSR) extends sequential randomization by taking into account the constraints of δₖ. However, in some embodiments this simple method suffers from two problems because of the network dependencies. First, the algorithm may come up with estimates that are non-causal. As mentioned above, an estimate for δₖ is non-causal (or not valid) if there is no node that is k-exposed or no node that is in control.

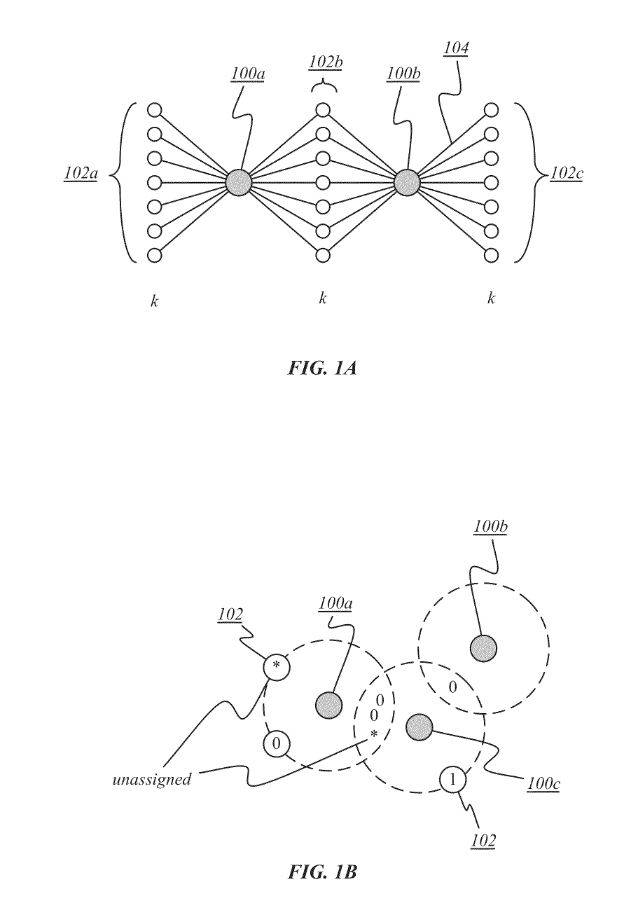

Second, depending on network structure, the estimate may be severely biased. For example, referring briefly to FIG. 1A, illustrated is a diagram of an embodiment of a social graph with a “candy network” illustrating the effects of selection bias (named for its wrapped candy shape). There are two nodes 100a-100b in Vₖ (shaded), connected via connections 104 to neighbors 102a-102c. Causal estimates can only be obtained when one node is k-exposed, the other is non-exposed, and we compare between the two observed outcomes. However, this can only happen when all middle nodes 102b (shared neighbors) are put in control. The probability of this happening through SSR is very small. Furthermore, since only 2 out of the

$${( \begin{matrix}2 k \\ k\end{matrix} )}^{2}$$

causal estimates can be observed, any estimate will be severely biased, and the resulting estimator might have infinite risk.

Accordingly, in a modified algorithm, a predetermined percentage x of the shared neighbors between nodes may be placed into control. This may increase the causal information acquired by a randomization at the expense of increased bias, and is shown in the following pseudocode:

Algorithm 2 Insulated Neighbors Randomization INR^{x} (G, Z).
Inputs: G network, Z treatment vector

w ← sample{n=x · | k|, k}
Z_{w} ← 0
Z ← SSR(G, Z) (i.e. algorithm 1 above)

FIG. 1B is a diagram of such an embodiment of a social graph with an insulated neighbors randomization (INR) algorithm used to identify a control group.

Causal Inference through Linear Model

The randomization based procedure above has the advantage of making no assumption about the response function of a k-level peer influence treatment. However, it assumes complete knowledge of the network. Furthermore, depending on the network topology, it may have trouble finding enough valid causal estimates. Moreover, treatment assignments may be difficult to administer in real world scenarios.

The complementary model-based procedure addresses these issues by being robust to treatment assignment. A linear network treatment model is used by assuming additivity of the primary effects and peer influence effects in their contribution to the treatment response mean. As edges in real world networks often represent an uncertain quantity of interactions between two individuals, the model may be extended by considering weighted random networks. Modeling the individual potential outcome as Yᵢ(Z)=τZi+γ(A^{T}Z)+μ+εᵢ, the population response can be expressed by the following linear equations:

y=Xβ+ [symbol] (5)

β=γ μ^{T} (6)

X=Z A^{T}Z 1 (7)

[symbol]

^{iid} N(0, σ²) (8)

y, a vector of size N, is the observed treatment response. X_{(Nx3)} is the explanatory matrix describing the treatments received by each individual. In the matrix X, the first column Z is the treatment vector; the second column A^{T}Z is the amount of peer influence from neighbors, with A being the weighted, directed adjacency matrix; and the third column is a unit vector giving each individual a baseline response. β is the coefficient vector containing τ, the strength of primary effects, γ the strength of peer influence effects, and μ the baseline response. Finally, ε, a vector of size N, gives each response independent variation identically distributed with N(0, σ²). The network only appears in A^{T}Z. S=A^{T}Z, a vector of size N, and serves as the sufficient network statistic for estimating β. Accordingly, S represents the amount of exposure to peer influence for each node and may thus be used to estimate the amount of effect due to said influence.

The linear model leads to simple expressions for the causal estimands. The primary effects estimand reduces to τ:

$$\begin{matrix}= \frac{1}{N} \begin{matrix}X \\ i\end{matrix} [ {Y}_{i} ( 1 , z = 0 ) - {Y}_{i} ( 0 ) ] \\ = \frac{1}{N} \begin{matrix}X \\ i\end{matrix} =\end{matrix} \qquad ( 9 )$$

The k-level peer influence effects estimand δₖ reduces to a scaled γ:

$$\begin{matrix}{δ}_{k} = \frac{1}{\vert {V}_{k} \vert} \begin{matrix}X \\ i\end{matrix} [ \text{?} ( {Y}_{i} ( 0 , z ) - {Y}_{i} ( 0 ) ) ] \\ = \frac{1}{\vert {V}_{k} \vert} \begin{matrix}X \\ i\end{matrix} [ \text{?} {S}_{i} ( z ) y ] \\ = \frac{ky}{\vert {V}_{k} \vert} \begin{matrix}X \\ i\end{matrix} {W}_{i} / y\end{matrix} \\ \text{?} \text{indicates text missing or illegible when filed} \qquad ( 10 )$$

where Wᵢ is the average weight on the incoming edges to i. Accordingly, the scale is k×the average W across the eligible nodes |Vₖ|. Estimating the causal estimands under the linear model therefore amounts to inferring τ and γ.

In many instances, real world networks may be uncertain, as true interactions between individuals may be either unobservable, or measured and estimated with error. In one embodiment, each edge of the network may be modeled as a Poisson distributed random variable with rate λᵢⱼ. In one embodiment, the rates may be known, while in another embodiment, the system may use a more general hierarchical model on the rates as a function of one or more network parameters, such as node degrees in an expected degree random graph or Chung-Lu model.

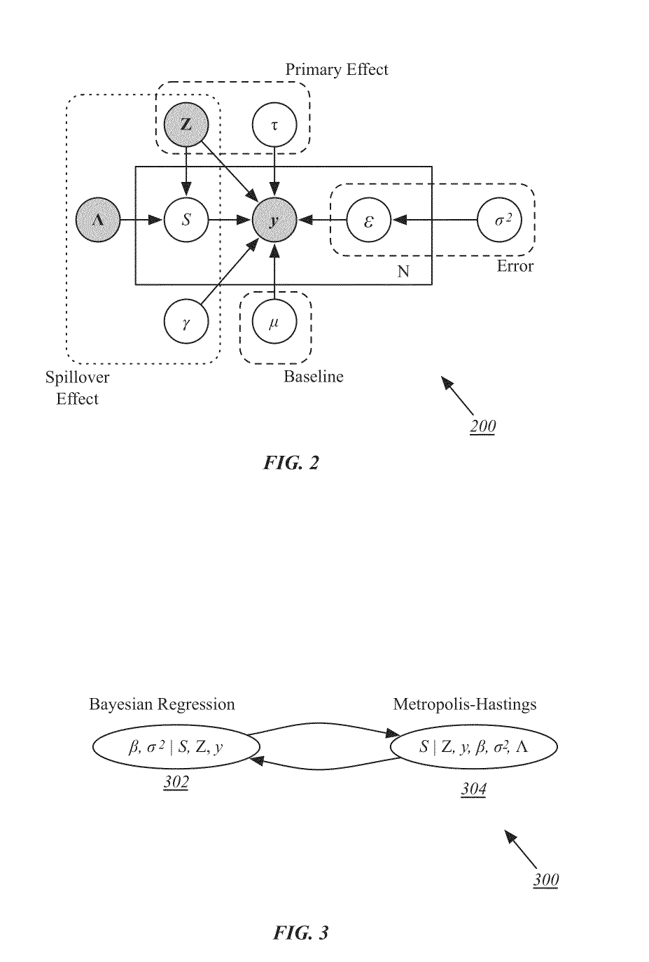

While the network A is random, it does not need to be imputed as missing data. Rather, the sufficient statistic S may be modeled, resulting in more efficient inference and avoiding identifiability issues. S, the exposure, may be modeled with the following distributions:

$$\begin{matrix}{A}_{ij} Pois ( {λ}_{ij} ) & ( 11 ) \\ {S}_{i} = {A}_{. i}^{T} ZPoise ( {κ}_{i} ) & ( 12 )\end{matrix}$$

where κ=ΛZ, Λ_{(NxN)} the interaction rate matrix, since S are sums of independent Poisson random variables. FIG. 2 illustrates a plate diagram 200 of an embodiment of a Poisson random network linear treatment Bayesian model for modeling network uncertainty, given the treatment assignment Z, the interaction rates A, and the responses y.

To determine S, β, and σ², inferences may be iteratively performed through a Markov Chain Monte Carlo algorithm using Gibbs sampling as shown in the exemplary state diagram 300 of FIG. 3, performing a Bayesian regression step 302 and a Metropolis-Hastings step 304 in repeated iterations.

In order to sample σ² more efficiently, away from zero, a weakly informative Normal-Inverse-gamma conjugate prior is used in Bayesian regression step 302. A large variance on the Normal is used to approximate a flat prior:

P₀(β, σ²)= [symbol] (β; μ₀=0, V₀=100I)×Inv-Gamma(σ²; a₀=2, b₀=2) (16)

The resulting posterior can be sampled by first drawing σ² then β

σ²|S, z, y˜Inv-Gamma(a*, b*) (17)

β|σ², S, z, y˜ [symbol] (μ*, V*) (18)

where X_{Nx3)}=[z S 1], V*=(V₀⁻¹+X^{T}X)⁻¹, μ*=(V₀⁻¹+X^{T}X)⁻¹(V₀⁻¹μ₀+X^{T}y), a*=a₀+n/2, b*=b₀+½(μ^{T}V₀⁻¹μ₀+y^{T}y−μ*^{T}V*¹μ*).

Conditioning on everything else, in the Metropolis-Hastings step 304, a random scan is performed through each Sᵢ by drawing from the following unnormalized closed-form posterior:

P(Sᵢz, y, β, σ², κᵢ)∝P(yᵢ|Sᵢ, z, β, σ²)×P₀(Sᵢ|κᵢ)= [symbol] (yᵢ; Xᵢ.β, σ²)×Pois(Sᵢ; κᵢ) (19)

A random walk proposal is used with a boundary at 0 (since the amount of peer influence effects is non-negative). The acceptance probability is the following (note the Hastings correction is only effective at the boundary):

$${P}_{acc} = min ( 1 , \frac{P ( {S}_{i}^{t + 1} \vert \cdot )}{P ( {S}_{i}^{t} \vert \cdot )} \frac{P ( {S}_{i}^{t + 1} \to {S}_{i}^{t} )}{P ( {S}_{i}^{t} \to {S}_{i}^{t + 1} )} ) \qquad ( 20 )$$

Theoretical Results

In some embodiments, for the randomization procedure discussed above, estimation bias and assignment manipulability are characterized as a function of the sharing index. The manipulability of a network G under randomization R is the average proportion % of valid causal estimates that R will get when ran on G. For the model-based procedure, variance of the estimate may be characterized through Fisher information analysis. This may be used to identify optimal assignments via observation of network topology effects on estimation performance.

As discussed above, network topology may be important in getting causal estimates for δₖ. For example, a complete graph with all units connected will not allow a valid causal estimate, since as soon as a unit is k-exposed, no other unit can be non-exposed. Conversely, for networks with isolated nodes, it may always be possible to draw valid causal estimates through a completely randomized experiment. In other words, we can think of networks as having varying degrees of manipulability, such that the complete graph has 0% manipulability and the isolated graph has 100% manipulability.

Under Assumption 1 above, interference happens through the shared neighborhood ₖ. Accordingly, the larger ₖ is with respect to the entire graph G, the stronger the interference effects should be. For example, if ₖ=, then there is no interference and a classical randomized experiment can be performed. This may be described as a sharing index α ∈[0, 1], defined for a given network as:

$$= \frac{1}{\vert {V}_{k} \vert} \begin{matrix}X \\ i 2 {V}_{k}\end{matrix} \frac{{m}_{ik}}{{n}_{i}} \qquad ( 13 )$$

A high sharing index may indicate that whenever a node is k-exposed or non-exposed, it will affect more of the remaining nodes, making the graph less manipulable. For example, given a G_{n,p} Erdös-Rényi graph, as the sharing index increases, a greater number of nodes are interconnected. Taken to the extreme, one arrives at the complete graph discussed above with 0% manipulability. In some embodiments of networks, manipulability decreases with an exponential rate as the sharing index increases.

In some embodiments, the bias of the estimator provided by INR^{1.0} is proportional to the sharing index:

Theorem 1. If ∀i, ρᵢ=ρ and ρ_{0,i}=ρ₀, such that ρ/ρ₀=1α≦1, then:

E[\hat{δ}_{k, I N R}]=δₖ+·(δ_{k,0}−δ_{k,1}) (14)

The bias of INR^{1.0} estimates come from two sources: first from the sharing index of the network, and second from the difference of the influence that nodes in ₖ (shared neighbors) exert compared with nodes in V\ₖ. If the shared neighbors are more (or less) influential, for example because of their better positioning on the network, the estimates will be biased.

For an ego-centric network with no commonly shared nodes (α=0), the estimate from INR is unbiased. Furthermore, if peer influence effects are invariant to permutations of node ids (such that δ_{k,0}=δ_{k,1}), the estimate from INR is unbiased.

Other than biasedness, the performance of the inference procedure is typically characterized by the variance of the estimate. As discussed above, the structure of the network and treatment assignment may play a role in the variance, through the Fisher information matrix and the Cramér-Rao bound. From the above Bayesian model, the likelihood is:

$${L}_{y} ( , γ , μ , S , {σ}^{2} \vert κ , z ) = \begin{matrix}Y \\ i\end{matrix} N ( {y}_{i} ; {z}_{i} + {S}_{i} γ + μ , {σ}^{2} ) \\ Pois ( {S}_{i} ; {κ}_{i} ) \qquad ( 15 )$$

After Normal approximation of Poisson: Pois(κi)≈N(κᵢ, κᵢ) and integrating out the nuisance parameter S by Normal representation, the Fisher information matrix may be computed from a log likelihood as :

$$\begin{matrix}I ( β , {σ}^{2} ) = - E ( \frac{{\partial }^{2} {l}_{y} ( β , {σ}^{2} \vert κ , z )}{\partial [ τ , γμ , {σ}^{2} ] \partial [ τ , γ , μ , {σ}^{2} ]} ) = \\ = [ \begin{matrix}{\sum }_{i} \frac{{z}_{i}}{{φ}_{i}} & {\sum }_{i} \frac{{z}_{i} {κ}_{i}}{{φ}_{i}} & {\sum }_{i} \frac{{z}_{i}}{{φ}_{i}} & 0 \\ … & {\sum }_{i} [ \frac{{κ}_{i}^{2}}{{φ}_{i}} - \frac{2 {γ}^{2} {κ}_{i}^{2}}{{φ}_{i}^{2}} ] & {\sum }_{i} \frac{{κ}_{i}}{{φ}_{i}} & 0 \\ … & … & {\sum }_{i} \frac{1}{{φ}_{i}} & 0 \\ … & … & … & {\sum }_{i} \frac{1}{2 {φ}_{i}^{2}}\end{matrix} ]\end{matrix}$$

where φᵢ=σ²+γ²κᵢ. The diagonal entries of the matrix reveal the information source for each parameter. Being mostly interested in the causal estimands τ and γ, we focus on I(1,1) and I(2,2). Since the rate of peer influence exposures K are relatively large, the first term in I(2,2) dominates the second term. So we focus on

$${\sum }_{i} \frac{{z}_{i}}{{σ}^{2} + {γ}^{2} {κ}_{i}}$$

### for I(1,1) and

$${\sum }_{i} \frac{{κ}_{i}^{2}}{( {σ}^{2} + {γ}^{2} {κ}_{i} )}$$

for I(2,2). The information content for ti comes from the treated nodes but is discounted by the rate of peer influence it receives. On the other hand, the information content for γ comes from having large amount of peer influences. This presents a tug of war between minimizing the variance on \hat{τ} and \hat{γ}. Trying to meet both objectives in some embodiments may lead to a treatment assignment where the hubs are treated to maximize overall peer influence while controlling their neighbors to minimize the peer influence to the treated nodes. These “isolated” treated hubs may result in a treatment assignment strategy that is very similar to the INR randomization.

While the Cramér-Rao bound (I⁻¹) is complicated and does not readily render intuition, one can compute it numerically and find the expected estimation variance. This can be used to numerically determine the minimal variance treatment assignment.

Empirical Results

The main idea behind INR is to increase manipulability of a network at the cost of introducing more bias. Consider, for example, the candy network of FIG. 1A, discussed above. Under SSR, there is

$$2 / ( \begin{matrix}2 k \\ k\end{matrix} ) ∝ {2}^{- 4 k}$$

probability of getting a causal estimate. In contrast, INR^{1.0} will get causal estimates in 50% of the randomizations since all middle nodes (shared neighbors) will be put under control right away.

The performance of the proposed randomization-based and model-based causal estimators may be compared empirically. To introduce variety, different networks may be utilized, such as 100-node networks, each with different type of topologies commonly seen in real-world networks. Two underlying response functions to the treatment are tested with the results shown in Tables 2 and 3 below. The first one (Table 2) is based on the proposed linear response model γᵢ=τzⁱ+γSᵢ+μ+εᵢ and the second one (Table 3) adds a quadratic term ηSᵢ² to the response, signifying the phenomenon that somehow the peer influence reinforce each other. The level-4 peer influence effects causal estimand, δ4, is used as the objective or truth. In the example shown, the true values for each response parameter are τ=10, γ=0.5, μ=3, εᵢ N(0, 1), η=0.05. The results for SSR, INR^{0.6}, a linear model with 15 random treatments (LMR), and a linear model with 15 optimal treatments (LMO) are summarized in Tables 2 and 3:

TABLE 2
results of the linear response function on each network, listed as mean(σ).

| | | | ( ) | | | |
|---|---|---|---|---|---|---|
| Graphs | | | Estimation strategy | | | |
| Type | Parameters | Truth: δ₄ | SSR | INR^{0.6} | LMR | LMO |
| Small world | p = 0.05 | 11.18 | 10.49(2.04) | 9.15(2.36) | 10.85(1.09) | 9.7(0.63) |
| | p = 0.5 | 11.45 | 11.45(1.82) | 10.60(2.60) | 11.31(1.08) | 11.66(0.76) |
| | p = 0.9 | 12.97 | 12.54(1.35) | 12.17(1.57) | 12.82(1.54) | 12.42(0.72) |
| 4-community | diag(0.9)/off(0.1) | 3.19 | 3.47(0.59) | 3.34(0.61) | 3.15(0.56) | 3.37(0.26) |
| block model | diag(0.25)/off(0.75) | 3.28 | 3.56(0.74) | 3.77(0.82) | 3.28(0.27) | 3.72(0.23) |
| | Beta(0.1, 0.1) | 3.19 | 3.2(0.49) | 3.51(0.57) | 3.25(0.36) | 3.28(0.21) |
| | Beta(1, 1) | 3.27 | 3.41(0.57) | 3.6(0.65) | 3.30(0.33) | 3.40(0.22) |
| Chung-Lu | — | 2.88 | 2.9(0.61) | 2.96(0.5) | 2.99(0.31) | 2.93(0.21) |

Table 2 shows that when the model assumption is correct, the model-based approach out-performs the randomization-based approach, both in estimate bias and variance. LMO consistently achieves smaller variance than LMR, which is consistent with the theoretical result discussed above.

TABLE 3
results of the quadratic response function on each network, listed as mean
(σ).

| Graphs | | | Estimation strategy | | | |
|---|---|---|---|---|---|---|
| Type | Parameters | Truth: δ₄ | SSR | INR^{0.6} | LMR | LMO |
| Small world | p = 0.05 | 42.46 | 36.38(10.7) | 32.13(13.96) | 25.37(3.96) | 27.32(1.49) |
| | p = 0.5 | 44.68 | 45.73(10.01) | 39.52(14.24) | 27.27(4.15) | 35.45(2.05) |
| | p = 0.9 | 50.52 | 47.54(7.00) | 46.87(9.12) | 33.39(4.38) | 36.00(1.80) |
| 4-community | diag(0.9)/off(0.1) | 5.48 | 5.97(1.25) | 5.77(1.45) | 6.64(0.9) | 9.28(0.66) |
| block model | diag(0.25)/off(0.75) | 5.63 | 6.01(1.26) | 7.05(1.81) | 8.96(1.20) | 11.25(0.61) |
| | Beta(0.1, 0.1) | 5.42 | 5.63(0.94) | 6.0(1.37) | 8.40(1.19) | 9.24(0.52) |
| | Beta(1, 1) | 5.59 | 6.07(1.08) | 6.52(1.43) | 6.53(0.75) | 9.01(0.46) |
| Chung-Lu | — | 4.65 | 4.83(0.75) | 4.9(0.87) | 6.87(0.74) | 6.69(0.34) |

Table 3 shows that when the model assumption is incorrect, the attempt to capture nonlinear effects in linear terms result in biased estimates for the model-based approach. Here, the randomization-based approach is the better choice resulting in estimates much closer to the true value. Additionally, INR^{0.6} is more biased compared to SSR, but achieves higher manipulability as discussed above. Accordingly, different algorithms may be used in different embodiments, depending on problem-specific considerations.

Adopting the potential outcomes framework for causal inference, a novel k-level estimand may be defined for peer influence effects estimated via, in various embodiments, a randomization-based approach or a model-based approach. The randomization based approach, INR, is generalization of a sequential randomized design that aims to get more causal information with increased manipulability at the expense of increased bias, especially in dense networks. The model-based approach performs efficient causal estimation in the presence of network uncertainty, when the additivity assumption holds. Furthermore, the model informs optimal assignment through maximizing Fisher information.

### B. Systems and Methods for Application of Causal Peer Influence Effect Estimation

The algorithms and methods described above can be used to identify primary influencers of a user within a social graph, providing enhanced business intelligence to advertisers, marketers or other entities. For example, by iteratively performing an estimation of causal interference effects on all neighbors or linked users of a target user, the neighbors with the highest amount of influence on the target user or primary influencers may be identified and their amount of influence estimated. Such estimations may be used, for example, to identify products purchased by the influencers for marketing to the target user.

Similarly, with other variables, influence estimations may be used in other contexts, including military intelligence or foreign affairs, education, healthcare, or other industries. For example, given a social network of leadership of a foreign regime, the major influencers may be identified and targeted for negotiations, or online influences may be identified for inducing social unrest offline. In the healthcare industry, vaccinations or other preventative care may be targeted to those who have the greatest amount of influence on neighbors within a region, such as people who have the most contact with the public. In the education industry, influential students may be targeted for additional tutoring, as improving their understanding of a topic may lead to improving the understanding of the entire class. Such influences may be identified and estimated via embodiments of the above-discussed algorithms.

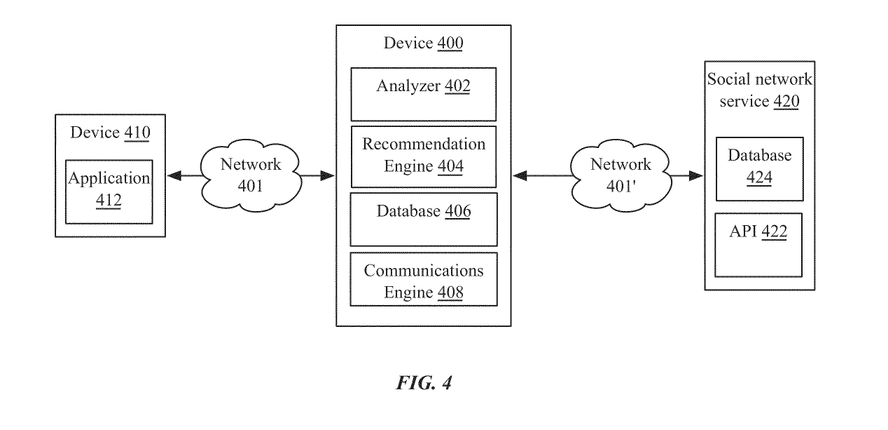

Referring to FIG. 4, illustrated is a diagram of an embodiment of a system for analysis and application of causal effects within a social network. A device 400 may comprise an analyzer 402, recommendation engine 404, database 406, and communications engine 408. Via the communications engine 408, the device 400 may communicate via one or more networks 401, 401′ such as a local area network, wide area network, or any other type and form of network or combination of networks with one or more user or client devices 410 and one or more social media or social network services 420. The client device 410 may execute an application 412, such as a web browser or dedicated application for generating and transmitting queries to device 400 for analysis, and/or for receiving and displaying analysis results or recommendations.

Social network service 420 may comprise one or more servers, database providers, cloud service providers or other entities for providing information about a network of users and their interconnections. Social network service 420 may maintain a database of user information 424, which may include an identification of the user, such as a name, ID or GUID, account name, or other such identification; information about the user including demographic information such as age, location, profession, gender, or any other such information; information about user purchases or preferences, including explicit preferences (e.g. items the user has “liked” or indicated a positive (or negative) preference for) and implicit preferences (e.g. items on which the user has repeatedly commented in a positive way, such as discussions about concerts associated with a particular band); and information about user connections to other users. This information may form a multi-dimensional graph, allowing queries of relationships between users by any variable, such as age, region, whether the user has purchased a particular product, whether the user has received a particular medical treatment, etc. Social network service may comprise any type and form of social network, such as the Facebook social network provided by Facebook, Inc.; the Google Plus social network provided by Google, Inc.; the Twitter social network provided by Twitter, Inc.; an FDA database of a patient cohort for a medication study; a student database at a school; or any other type and form of network of users and connections between users. In many embodiments, the social network service 420 may provide an application programming interface 422 for transmitting queries to the network service 420, such as queries for users connected to a first user, or queries for demographic or profile information of a user. In some embodiments, the system may have access to the entire social network or database of social network profiles, for example, if the system is maintained by the owner or provider of the social network. In other embodiments, the system may have access to only a portion of the social network. For example, the system may be maintained by a user or client of the social network or social media platform, and may analyze a subset of profiles available to the user or client, such as profiles of “friends”, uses who have “liked” a specific item, participants in a survey, volunteers, participants in a game or promotion, or other such users.

The device 400 may execute an analyzer 402. Analyzer 402 may comprise an application, service, daemon, routine, server, or other executable logic for analyzing and estimating the magnitude of causal effects as discussed above. In some embodiments, analyzer 402 may perform repeated iterations of estimations of causal effects of influence a selected user on a target user with respect to a target variable, allowing analyzer 402 to identify one or more users with the greatest influence on the target user. For example, given a target user or group of users, the analyzer 402 may be used to identify the strongest influencers of said user or group of users with respect to a variable, such as a product to be purchased or a political position.

Device 400 may include a recommendation engine 404, which may comprise an application, service, server, daemon, routine, or other executable logic for providing a recommendation of a selected variable position to present to a target user responsive to a causal influence analysis from analyzer 402. Although shown separate, in many embodiments, recommendation engine 404 may comprise part of analyzer 402 or they may be sub-modules of an analysis and recommendation engine (not illustrated). In one embodiment, based on an identification of one or more influencers of a target user, recommendation engine 404 may be used to identify products or offers that should be presented to the target user. For example, the recommendation engine may present an identification of products that should be prioritized in an advertising campaign or products that may provide upsell opportunities for purchasers, based on influencers of a group and their purchase histories. In other embodiments, the recommendation engine may be used for A/B testing by identifying influencers of a group and their preferences, and presenting suggested modifications or selections of variables responsive to preferences of the influencers.

Device 400 may maintain a database 406 in many embodiments. The database 406 may comprise a database, flat file, data file, or other format of data storage for maintaining an identification of influencers and corresponding amount of influence on a network or subnetwork, offers, product recommendations, or other such information. In some embodiments, influence estimations may be maintained or cached for a period of time to reduce processing requirements for frequent queries of the same networks. In other embodiments, the database 406 may comprise database 424 and/or store social network profiles, CRM data, eCommerce data, or other such data. Accordingly, in some embodiments, device 400 may maintain a social network database and not need to communicate with social network service 420.

Communications engine 408 may comprise an application, service, server, daemon, network stack, or other executable logic for transmitting and receiving queries, responses, and/or recommendations to a social network service 420 and/or a device 410. Communications engine 408 may include a network interface card (NIC) or other hardware or communicate with such hardware. Although shown deployed between device 410 and social network service 420, in many embodiments, device 400 may connect to a single network connected to said device 410 and service 420, with communications engine 408 handling routing of communications.

In some embodiments, the system may be used for graph computation and abstraction of a social network to identify influences. In other embodiments, the system may be used for ranking potential offers or estimated preferences of a user. For example, the system may identify a cohort that a user belongs to, identify the influencers of that cohort, identify the purchases made by those influencers, and recommend one product over another product to the user. In other embodiments, the system may be used to design A/B tests by identifying influencers of a group based on one or more variables, such as likelihood of response to a type of offer, different offer channels, different offer layouts or creative features, etc.

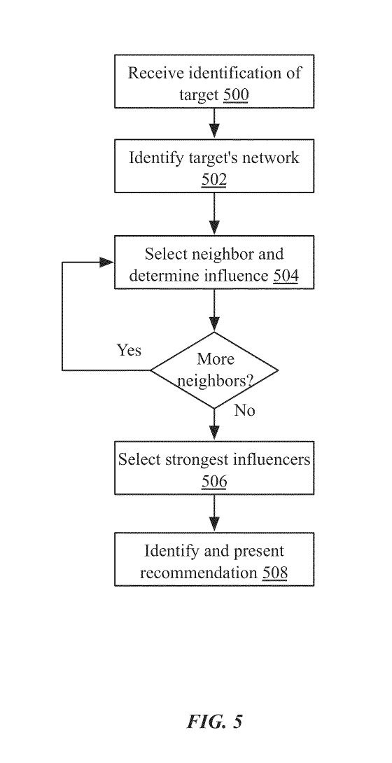

Referring briefly to FIG. 5, illustrated is a flow chart of an embodiment of a method for presenting an offer to a user based on an estimation of causal influence effects. At step 500, in some embodiments, the analyzer may receive an identification of a target, such as a user or node of a graph. In many embodiments, the analyzer may also receive an identification of a variable or treatment, as discussed above.

At step 502, the analyzer may identify the target's network or subnetwork. In some embodiments, the analyzer may retrieve a network associated with the target from a database or social network service.

At step 504, the analyzer may select a neighbor of the target within the network and may estimate the influence of the neighbor on the target using one or more of the algorithms discussed herein. As discussed above, the choice of algorithm may be dependent on network type, and may be configured by an administrator of the system or may be selected based on a policy applied to the network. For example, a policy may determine what percentage of the nodes are connected or how complete the network is, and/or how manipulable the network is, and may select from an SSR or INR algorithm accordingly. In many embodiments, step 504 may be repeated iteratively for multiple neighbors or influencers of the target to estimate the causal effect of each influencer on the target. The causal effect may be scored, or the analyzer may assign a score to the causal effect, for each neighbor or influencer of the target.

At step 506, the analyzer may select one or more of the strongest influencers on the target. In one embodiment, a threshold may be applied and influencers with an effect score above the threshold may be selected. In another embodiment, a predetermined number of influencers may be selected in order of strongest influence.

At step 508, a recommendation may be selected and presented for the target user, based off a variable status of the one or more selected influencers. For example, if the influencers all purchased a particular product, a recommendation for the product may be presented to the target user, as discussed above. Variable statuses may include explicit or implicit preferences identified by the influence (e.g. “likes”, purchases, Internet searches, keywords included in messages, etc.). Recommendations may include advertising; coupons; suggested topics, articles, or websites of interest; suggested products for purchase; suggested items of content such as audio, video, or multimedia; or any other type and form of recommendation.

Accordingly, by quantifying causal peer influence within a social network, influencers of a group, or individuals with a greater amount of influence on the group, may be identified and their amount of influence on the group or a subset of the group estimated. The analysis may provide actionable insights into the group, allowing improved marketing or advertising results, prioritization of offers, improved design and execution of A/B tests, or other such features.

### C. Embodiments of Exemplary Computing Devices

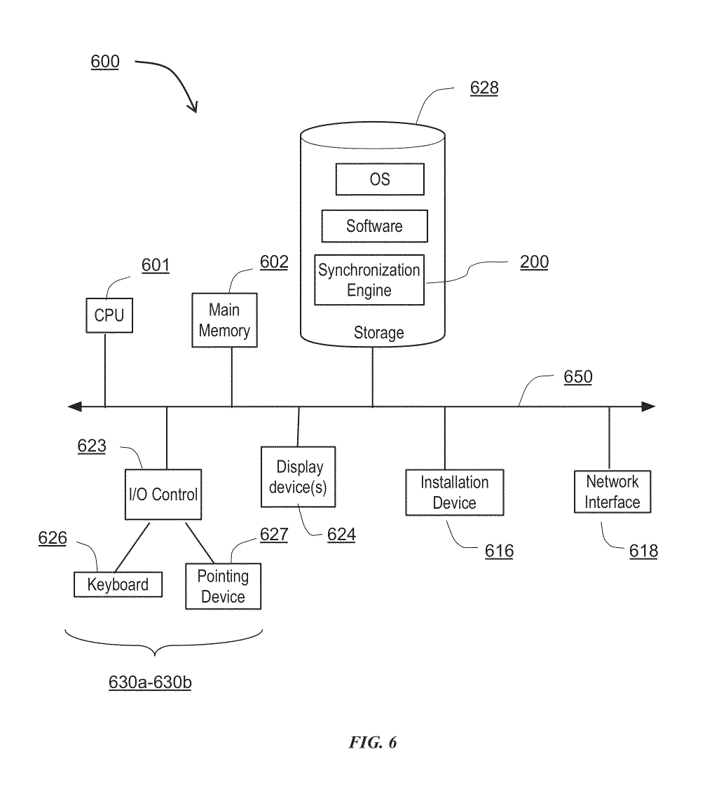

FIG. 6 is a block diagram of an exemplary computing device useful for practicing the methods and systems described herein. The various devices 400, 410, 420, may be deployed as and/or executed on any type and form of computing device, such as a computer, network device or appliance capable of communicating on any type and form of network and performing the operations described herein. The computing device may comprise a laptop computer, desktop computer, virtual machine executed by a physical computer, tablet computer, such as an iPad tablet manufactured by Apple Inc. or Android-based tablet such as those manufactured by Samsung, Inc. or Motorola, Inc., smart phone or PDA such as an iPhone-brand/iOS-based smart phone manufactured by Apple Inc., Android-based smart phone such as a Samsung Galaxy or HTC Droid smart phone, or any other type and form of computing device. FIG. 6 depicts a block diagram of a computing device 600 useful for practicing an embodiment of the user devices 400, 410 or device of a social media provider 420. A computing device 600 may include a central processing unit 601; a main memory unit 602; a visual display device 624; one or more input/output devices 630a-630b (generally referred to using reference numeral 630), such as a keyboard 626, which may be a virtual keyboard or a physical keyboard, and/or a pointing device 627, such as a mouse, touchpad, or capacitive or resistive single- or multi-touch input device; and a cache memory 640 in communication with the central processing unit 601.

The central processing unit 601 is any logic circuitry that responds to and processes instructions fetched from the main memory unit 602 and/or storage 628. The central processing unit may be provided by a microprocessor unit, such as: those manufactured by Intel Corporation of Santa Clara, Calif.; those manufactured by Motorola Corporation of Schaumburg, Ill.; those manufactured by Apple Inc. of Cupertino Calif., or any other single- or multi-core processor, or any other processor capable of operating as described herein, or a combination of two or more single- or multi-core processors. Main memory unit 602 may be one or more memory chips capable of storing data and allowing any storage location to be directly accessed by the microprocessor 601, such as random access memory (RAM) of any type. In some embodiments, main memory unit 602 may include cache memory or other types of memory.

The computing device 600 may support any suitable installation device 616, such as a floppy disk drive, a CD-ROM drive, a CD-R/RW drive, a DVD-ROM drive, tape drives of various formats, USB/Flash devices, a hard-drive or any other device suitable for installing software and programs such as any client agent 620, or portion thereof. The computing device 600 may further comprise a storage device 628, such as one or more hard disk drives or redundant arrays of independent disks, for storing an operating system and other related software, and for storing application software programs such as any program related to the client agent 620.

Furthermore, the computing device 600 may include a network interface 618 to interface to a Local Area Network (LAN), Wide Area Network (WAN) or the Internet through a variety of connections including, but not limited to, standard telephone lines, LAN or WAN links (e.g., Ethernet, T1, T3, 56 kb, X.25), broadband connections (e.g., ISDN, Frame Relay, ATM), wireless connections, (802.11a/b/g/n/ac, BlueTooth), cellular connections, or some combination of any or all of the above. The network interface 618 may comprise a built-in network adapter, network interface card, PCMCIA network card, card bus network adapter, wireless network adapter, USB network adapter, cellular modem or any other device suitable for interfacing the computing device 600 to any type of network capable of communication and performing the operations described herein.

A wide variety of I/O devices 630a-630n may be present in the computing device 600. Input devices include keyboards, mice, trackpads, trackballs, microphones, drawing tablets, and single- or multi-touch screens. Output devices include video displays, speakers, headphones, inkjet printers, laser printers, and dye-sublimation printers. The I/O devices 630 may be controlled by an I/O controller 623 as shown in FIG. 6. The I/O controller may control one or more I/O devices such as a keyboard 626 and a pointing device 627, e.g., a mouse, optical pen, or multi-touch screen. Furthermore, an I/O device may also provide storage 628 and/or an installation medium 616 for the computing device 600. The computing device 600 may provide USB connections to receive handheld USB storage devices such as the USB Flash Drive line of devices manufactured by Twintech Industry, Inc. of Los Alamitos, Calif.

The computing device 600 may comprise or be connected to multiple display devices 624a-624n, which each may be of the same or different type and/or form. As such, any of the I/O devices 630a-630n and/or the I/O controller 623 may comprise any type and/or form of suitable hardware, software embodied on a tangible medium, or combination of hardware and software to support, enable or provide for the connection and use of multiple display devices 624a-624n by the computing device 600. For example, the computing device 600 may include any type and/or form of video adapter, video card, driver, and/or library to interface, communicate, connect or otherwise use the display devices 624a-624n. A video adapter may comprise multiple connectors to interface to multiple display devices 624a-624n. The computing device 600 may include multiple video adapters, with each video adapter connected to one or more of the display devices 624a-624n. Any portion of the operating system of the computing device 600 may be configured for using multiple displays 624a-624n. Additionally, one or more of the display devices 624a-624n may be provided by one or more other computing devices, such as computing devices 600a and 600b connected to the computing device 600, for example, via a network. These embodiments may include any type of software embodied on a tangible medium designed and constructed to use another computer's display device as a second display device 624a for the computing device 600. One ordinarily skilled in the art will recognize and appreciate the various ways and embodiments that a computing device 600 may be configured to have multiple display devices 624a-624n.

A computing device 600 of the sort depicted in FIG. 5 typically operates under the control of an operating system, such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein.

The computing device 600 may have different processors, operating systems, and input devices consistent with the device. For example, in one embodiment, the computer 600 is an Apple iPhone or Motorola Droid smart phone, or an Apple iPad or Samsung Galaxy Tab tablet computer, incorporating multi-input touch screens. Moreover, the computing device 600 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software embodied on a tangible medium, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code

What is claimed:

1. A system for applying quantified causal peer influence within a social network, comprising:
a first device in communication with a second device of a social network service, the first device comprising a processor configured for executing an analyzer and a recommendation engine;
wherein the analyzer is configured to:
receive an identification of a first target within the social network,
retrieve an identification of a plurality of targets neighboring the first target,
calculate, for each of the plurality of targets neighboring the first target, an influence score, and
identify, based on the calculated influence scores for each of the plurality of targets neighboring the first target, a first influencer of the first target; and
wherein the recommendation engine is configured to:
identify a first status of the first influencer,
select, from a database, a first recommendation associated with the identified first status, and
transmit the selected first recommendation to a second device of the first target.

2. The system of claim 1, wherein the analyzer is further configured to receive the identification of the plurality of targets neighboring the first target from a device of the social network service.

3. The system of claim 1, wherein the analyzer is further configured to:
identify a percentage of the plurality of targets that are interconnected; and
determine whether the identified percentage is above a predetermined threshold.

4. The system of claim 3, wherein the analyzer is further configured to calculate the influence scores via insulated neighbors randomization (INR), responsive to the identified percentage being below the predetermined threshold.

5. The system of claim 3, wherein the analyzer is further configured to calculate the influence scores via simple sequential randomization (SSR), responsive to the identified percentage being above the predetermined threshold.

6. The system of claim 1, wherein the analyzer is further configured to identify, as the first influencer, a target neighboring the first target having a highest calculated influence score of the plurality of targets.

7. The system of claim 6, wherein the analyzer is further configured to identify, as the first influencer, a target neighboring the first target having a calculated influence score above a predetermined threshold.

8. The system of claim 1, wherein the recommendation engine is further configured to identify the first status as the most recent status of a plurality of statuses of the first influencer.

9. The system of claim 1, wherein the first recommendation associated with the identified first status comprises a recommendation of the first status to the first target.

10. The system of claim 1, wherein the analyzer is further configured to identify a second influencer of the first target, based on the calculated influence scores for each of the plurality of targets; and
wherein the recommendation engine is further configured to identify a second status of the second influencer, and select the first recommendation associated with the identified first status and second status.

11. A method for applying quantified causal peer influence within a social network, comprising:
receiving, by an analyzer executed by a first device in communication with a second device of a social network service, an identification of a first target within the social network;
retrieving, by the analyzer, an identification of a plurality of targets neighboring the first target;
calculating, by the analyzer for each of the plurality of targets neighboring the first target, an influence score;
identifying, by the analyzer, a first influencer of the first target based on the calculated influence scores for each of the plurality of targets neighboring the first target;
identifying, by a recommendation engine executed by the first device, a first status of the first influencer;
selecting, by the recommendation engine from a database, a first recommendation associated with the identified first status; and
transmitting, by the recommendation engine, the selected first recommendation to a second device of the first target.

12. The method of claim 11, wherein receiving the identification of the first target within the social network further comprises receiving the identification of the first target from a device of the social network service.

13. The method of claim 11, further comprising:
identifying, by the analyzer, a percentage of the plurality of targets that are interconnected; and
determining, by the analyzer, whether the identified percentage is above a predetermined threshold.

14. The method of claim 13, further comprising calculating, by the analyzer, the influence scores via insulated neighbors randomization (INR), responsive to the identified percentage being below the predetermined threshold.

15. The method of claim 13, further comprising calculating, by the analyzer, the influence scores via simple sequential randomization (SSR), responsive to the identified percentage being above the predetermined threshold.

16. The method of claim 11, wherein identifying the first influencer further comprises identifying, as the first influencer, a target neighboring the first target having a highest calculated influence score of the plurality of targets.

17. The method of claim 16, further comprising identifying, as the first influencer, a target neighboring the first target having a calculated influence score above a predetermined threshold.

18. The method of claim 11, further comprising identifying, by the recommendation engine, the first status as the most recent status of a plurality of statuses of the first influencer.

19. The method of claim 11, wherein the first recommendation associated with the identified first status comprises a recommendation of the first status to the first target.

20. The method of claim 11, further comprising:
identifying, by the analyzer, a second influencer of the first target, based on the calculated influence scores for each of the plurality of targets;
identifying, by the recommendation engine, a second status of the second influencer; and
selecting, by the recommendation engine, the first recommendation associated with the identified first status and second status.
